(19) United States
(12) Patent Application Publication
(10) Pub. No.: US 2021/0380137 A1
(43) Pub. Date: Dec. 9, 2021

(54) MULTI-STAGE EXTERNAL COMMUNICATION OF VEHICLE MOTION AND EXTERNAL LIGHTING

(71) Applicant: Toyota Motor Engineering & Manufacturing North America, INC., Plano, TX (US)

(72) Inventors: Joshua E. DOMEYER, Madison, WI (US); Benjamin P. Austin, Saline, MI (US); John K. LENNEMAN, Okemos, MI (US)

(73) Assignee: Toyota Motor Engineering & Manufacturing North America, INC., Plano, TX (US)

(21) Appl. No.: 16/894,111

(22) Filed: Jun. 5, 2020

(51) Int. Cl. B60W 60/00; B60Q 5/00; B60W 10/22; B60W 10/18; B60W 10/30; B60G 17/015; G06K 9/00

(52) U.S. Cl. CPC B60W 60/0017; B60G 2202/42; B60W 60/0027; B60W 10/22; B60W 10/18; B60W 10/30; B60G 17/0155; G06K 9/00791; B60W 2420/52; B60W 2420/42; B60W 2554/4029; B60W 2554/4044; B60W 2554/4048; B60W 2554/4026; B60Q 5/006

(57) ABSTRACT

A method, system and non-transitory computer readable medium for multi-stage communication between an autonomous vehicle and a road user. The autonomous vehicle uses vehicle external cameras, a LiDAR sensors and radar sensors to image the surrounding environment. Image processing circuitry is used to develop a view of the surrounding environment from the sensed images and the view is combined with stored map data. Road users, which may include pedestrians, bicyclists, motorcyclists and non-autonomous vehicles are identified on the view and it is determined whether the movement of the road user will intersect the trajectory of the autonomous vehicle. The autonomous vehicle performs a vehicle behavior modification as a first stage signal to alert the road user of its intent. If the road user does not react to the first stage signal, the autonomous vehicle activates additional external lighting as a second stage signal to alert the road user.

### BACKGROUND

### Technical Field

The present disclosure is directed to multi-stage communication of vehicle motion to a road user. A first stage communication includes vehicle behavior and a second stage communication includes vehicle external lighting.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

An autonomous vehicle may be fully autonomous or perform only some self-driving maneuvers. For either type of vehicle, an autonomous vehicle must provide notifications to alert pedestrians and surrounding vehicles of the current or future actions of the autonomous vehicle in order to prevent accidents. These notifications can include flashing lights, electronic vehicle intent (eHMI) notification displays and audible sounds, such as horn sounds.

However, as autonomous vehicles become more prevalent on the roadways, the multitude of flashing lights, visible notifications by flashing lights, and eHMI displays and/or audible sounds may become overwhelming or confusing to a road user. Therefore, there is a need to provide the intent of the autonomous vehicle to a road user by other means.

In the past, eHMIs have been used without taking into consideration that they operate in a system of vehicle and pedestrian behaviors. This patent disclosure intends to bridge that gap by describing a strategy where they are integrated.

Accordingly, it is one object of the present disclosure to provide methods and systems for multi-stage communication between an autonomous vehicle and a road user which uses vehicle behavior modification as a first stage signal to the road user before proceeding to a second stage of activating vehicle external lighting.

### SUMMARY

In an exemplary embodiment, a method for multi-stage communication between an autonomous vehicle and a road user is described, comprising identifying a future interaction between the autonomous vehicle and a road user by one or more sensors, performing a vehicle behavior modification as a first stage communication, recognizing whether the road user is reacting to the vehicle behavior modification, and activating additional external lighting as a second stage communication when the road user is not reacting to the vehicle behavior modification.

In another exemplary embodiment, a system for multi-stage communication between an autonomous vehicle and a road user is described, comprising the autonomous vehicle including a plurality of sensors configured to generate images of the surrounding environment, the plurality of sensors including vehicle external cameras, LiDAR sensors and radar sensors, a plurality of suspension actuators for raising and lowering the vehicle chassis, wherein the plurality of suspension actuators are configured for independent actuation, a plurality of eHMI displays located at different external positions on the autonomous vehicle, wherein the plurality of eHMI notification displays are configured for independent activation, a plurality of additional external lighting displays, wherein the fourth plurality are configured for independent activation, a computing device including a computer-readable medium comprising program instructions, executable by processing circuitry, to cause the processing circuitry to receive image data from any one of the plurality of sensors, process the images to form a global view of the environment surrounding the autonomous vehicle, identify a first trajectory of the autonomous vehicle from the global view, identify a road user moving on a second trajectory which intersects the first trajectory, determine a gaze direction of the road user, estimate the intent of the road user to intersect a trajectory of the autonomous vehicle, perform a vehicle behavior modification as a first stage communication, recognize whether the road user is reacting to the vehicle behavior modification, and activate one or more of the plurality of eHMI notification displays and the plurality of additional external lighting as a second stage communication when the road user is not reacting to the vehicle behavior modification.

In another exemplary embodiment, a non-transitory computer readable medium having instructions stored therein that, when executed by one or more processor, cause the one or more processors to perform a method for multi-stage communication between an autonomous vehicle and a road user is described, comprising identifying a future interaction between the autonomous vehicle and a road user by one or more sensors, performing a vehicle behavior modification as a first stage communication, recognizing whether the road user is reacting to the vehicle behavior modification, and activating additional external lighting as a second stage communication when the road user is not reacting to the vehicle behavior modification.

The foregoing general description of the illustrative embodiments and the following detailed description thereof are merely exemplary aspects of the teachings of this disclosure, and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1 is a view of an exemplary autonomous vehicle, according to certain embodiments.

FIG. 2 is an illustration of active suspension components, according to certain embodiments.

FIG. 3 is an exemplary flowchart of an performing a multi-stage communication, according to certain embodiments.

FIG. 4 is illustrates the multi-stage communication between an autonomous vehicle and a pedestrian, according to certain embodiments.

FIG. 5 illustrates the multi-stage communication between an autonomous vehicle and two non-autonomous vehicles, according to certain embodiments.

FIG. 6 is a diagram of the computing device of the autonomous vehicle as it pertains to the multi-stage communication, according to certain embodiments.

FIG. 7 is an illustration of a non-limiting example of details of computing hardware used in the computing system, according to certain embodiments.

FIG. 8 is an exemplary schematic diagram of a data processing system used within the computing system, according to certain embodiments.

FIG. 9 is an exemplary schematic diagram of a processor used with the computing system, according to certain embodiments.

FIG. 10 is an illustration of a non-limiting example of distributed components which may share processing with the controller, according to certain embodiments.

### DETAILED DESCRIPTION

In the drawings, like reference numerals designate identical or corresponding parts throughout the several views. Further, as used herein, the words “a,” “an” and the like generally carry a meaning of “one or more,” unless stated otherwise. Furthermore, the terms “approximately,” “approximate,” “about,” and similar terms generally refer to ranges that include the identified value within a margin of 20%, 10%, or preferably 5%, and any values therebetween.

In the present disclosure, “road user” is defined as any of a non-autonomous vehicle, a pedestrian, a motorcyclist, a bicyclist, or any human driven conveyance.

Autonomous vehicles are described in commonly assigned U.S. Pat. No. 9,776,631, titled “Front vehicle stopping indicator,” and commonly assigned publication U.S. 2017/0057514 titled “Autonomous vehicle operation at multi-stop intersections” by some of the inventors of the present disclosure, both incorporated herein by reference in their entirety.

Aspects of this disclosure are directed to a method for multi-stage communication between an autonomous vehicle and a road user, a system for multi-stage communication between an autonomous vehicle and a road user and a non-transitory computer readable medium having instructions stored therein that, when executed by one or more processors, cause the one or more processors to perform a method for multi-stage communication between an autonomous vehicle and a road user.

An autonomous vehicle is a vehicle that is capable of sensing its environment and navigating with little or no user input. It senses the environment by using vehicle sensing devices such as radar, LiDAR, image sensors, and the like. Autonomous vehicles further use information from global positioning systems (GPS) technology, navigation systems, vehicle-to-vehicle communication, vehicle-to-infrastructure technology, and/or drive-by-wire systems to navigate the vehicle.

Autonomous vehicles typically include communication systems which are capable of exchanging information with other nearby autonomous vehicles about their trajectories, speed, intent to make turns, etc. A vehicle which includes a communication system is called a “connected vehicle” and may be autonomous, semi-autonomous or non-autonomous. The driver of a non-autonomous vehicle may be able to perceive the intent of other road users and take appropriate action to signal his/her intent and avoid the road user. For example, the driver may use a hand signal, a head nod, or other changes in body movement or posture to indicate that his/her intent is to let a pedestrian pass through an intersection before proceeding. However, an autonomous vehicle must use sensors to perceive the intent of non-autonomous road users and pedestrians and may communicate its movements by signaling, flashing lights or electronic vehicle intent notifications (eHMI).

The autonomous vehicle must be able to predict when a road user, such as pedestrian, a bicyclist or a driver of a non-autonomous vehicle, may impinge on its trajectory and must provide an indication of its future movements. There have been numerous proposals regarding methods that notify road users (e.g., pedestrians, cyclists, drivers of non-autonomous vehicles, etc.) of autonomous vehicle intent, many of which include additional lighting, such as flashing lights or eHMI displays and/or audible sounds.

Additionally, a road user, such as a pedestrian or non-autonomous vehicle, may not be able to see lighting or an eHMI notification on an autonomous vehicle which is still at a distance away but approaching his/her position. The road user can, however, see the autonomous vehicle and may be able to interpret the vehicle intent by visible cues derived from the behavior of the autonomous vehicle.

The present disclosure describes methods directed to aiding the communication between vehicle automation and other road users (e.g., pedestrians, cyclists and non-autonomous vehicles). Many original equipment manufacturers (OEMs) have identified that some sort of external communication may be necessary to help vehicle-to-other road user interaction (e.g., adding lights to the front of the vehicle). However, an alternative view is to use vehicle behavior (e.g., stopping profile) as the primary mechanism for communicating vehicle intent.

Aspects of the present disclosure merge vehicle behavior as the primary mechanism with additional lights on the front of the vehicle. For example, X meters away (or T seconds) from a pedestrian or non-autonomous vehicle, the vehicle automation may use a changed behavior of the vehicle as the primary communicative mechanism. However, as the vehicle approaches the pedestrian or non-autonomous vehicle, the external lighting on the front of the vehicle may turn on when a pedestrian has not responded to the vehicle behavior. In this way, the stages of communication are first reliant upon the vehicle behavior, and then at a threshold distance related to the speed or at a threshold time from collision would switch to communicating via external lighting.

In an aspect of the present disclosure, an autonomous vehicle merges the role of vehicle behavior with additional external lighting in a staged external communication system. When approaching a road user, the autonomous vehicle may at first indicate its future movements by its behavior and then switch to external lighting, (e.g., brake lights, turn signals, flashing headlights, eHMI notification displays) when close enough to the road user for the external lighting to be effective. In this way, the behaviors of the vehicle can be made clear prior to reaching the “external lighting” stage.

Aspects of the present disclosure are directed to notifying a road user of the intent of an autonomous vehicle to modify its behavior by using staged external communication.

The following is an example of using staged external communication to interact with a road user:

1. Identifying future interaction by one or more sensors, e.g., cameras, LiDAR, radar, and the like;

2. Performing a deceleration profile to indicate priority to the road user;

3. Recognizing the road user is not reacting to the deceleration profile (by head pose, body posture, movement, etc.);

4. Indicating stopping via an external communication device (e.g., lighting);

5. Stopping the autonomous vehicle.

The deceleration profile may include:
(i) stopping more abruptly or earlier on to indicate stopping to the road user;
(ii) vehicle behavioral changes, such as increasing the perceived size of the vehicle by exterior lighting or lowering the front of the vehicle (as shown in commonly assigned patent, U.S. Pat. No. 9,776,631, “brake dive signal”, “locking up a wheel and amplifying a sound”, “indication of a body roll”, incorporated herein by reference in its entirety);
(iii) decelerating more rapidly (as shown in commonly assigned U.S. patent publication US20170057514A1, incorporated herein by reference in its entirety);
(iv) a braking profile, such as multiple applications of the brakes in a pattern which generates high levels of jerking motion of the vehicle.

In an aspect of the present disclosure, the vehicle may recognize movements of a pedestrian road user. Recognizing the movements of the pedestrian road user may include a multi-gait profile including analysis of age, environment, arm swing, stride length, mood state, direction of movement, gaze direction indicating that the road user sees the vehicle, posture and gait. The vehicle behavior, additional exterior lighting or eHMI notification may be modified based on the multi-gait analysis.

If the autonomous vehicle is equipped with active or semi-active suspension capabilities, the behavior modification may include displaying vehicle attitude, such as a level of brake dive, to visually signal to occupants of non-autonomous vehicles, pedestrians or bicyclists that the autonomous vehicle is stopping or slowing down. Such a signal may be induced and/or further exaggerated by the vehicle control circuitry if available surplus traction capacity is determined, to indicate speed of stopping. An example brake dive signal may include at least one of the actions of lowering a front ride height and raising a rear ride height, such as by adjusting vehicle suspension components in real time. Exaggerated lowering of the front ride height and raising of the rear ride height mimics stopping the autonomous vehicle and would be recognized as such by a road user.

If the autonomous vehicle is equipped with active or semi-active suspension capabilities, the behavior may include a level of body roll to indicate a future turn. This behavior may be induced or further exaggerated by the vehicle control circuitry if available surplus traction capacity is determined to also allow for safe and adequate execution of the body roll. An example body roll signal may include at least one of the actions of lowering a first side ride height and raising a second side ride height, such as by adjusting vehicle suspension components in real time. In other words, vehicle dynamic behavior may be exaggerated. In an example, lowering the left side ride height and raising the right side ride height of the autonomous vehicle may indicate a left turn to a road user. In another example, raising the left side ride height and lowering the right side ride height of the autonomous vehicle may indicate a right turn to a road user. The vehicle 100 may display a greater change in pitch, roll, or yaw than necessary to serve as an indication to other road users of changes in their trajectory.

Communicating a sudden stop by vehicle behavior may be achieved by locking up a wheel of the autonomous vehicle briefly and generating a screeching or tire squealing sound. Locking the wheel briefly may indicate to a road user that the autonomous vehicle may not be able to safely stop before its trajectory crosses the trajectory of the road user. The autonomous vehicle may briefly lock the wheel repeatedly in a pattern. In a non-limiting example, if the autonomous vehicle determines that a pedestrian is entering a crossing street and there is at risk of impact at the current speed, the autonomous vehicle may begin a braking maneuver, briefly lock the left side wheel and emit a squealing sound, wait one second, briefly lock the right side wheel and emit a screeching sound. If the road user modifies his/her speed or stops, so that an accident may be avoided, the deceleration may be resumed normally. If the road user does not modify his/her speed or stop, the pattern may be repeated at one second intervals. The time period between repetitions of the behavior may vary depending on the speed of the autonomous vehicle and the distance from the road user. In a non-limiting example, the wheel may be briefly locked for a time period selected from the range of 0.5 second to 2 seconds. If the road user does not respond to the behavior modification of braking sharply and “squealing” or “screeching” sounds, as determined by changes in body posture, head pose or gaze direction, the staged external communication system may end the behavior modification and switch to communicating by the additional lighting and/or eHMI notification displays.

In a non-limiting example, the staged external communication system may include a first stage of modifying the behavior of the autonomous vehicle, such as a brake dive signal or body roll signal, determining if the road user reacts to the first stage, a second stage of raising the front of the vehicle which causes the vehicle to look larger as viewed from a distance (giving the appearance that the autonomous vehicle is closer to the road user) when the road user has not reacted to the first stage, and a third stage of providing a notification to the road user on an eHMI notification display when the first and second stages were ineffective.

In another non-limiting example, the staged external communication system may include a first stage of modifying the behavior of the autonomous vehicle by decelerating more rapidly than needed to stop, a second stage of flashing lights in a pattern which indicate the speed of the autonomous vehicle when the road user has not reacted to the first stage, and a third stage of providing a notification to the road user on an eHMI notification display when the road user has not reacted to the second stage. The notification may be a message or a symbol which indicates the autonomous vehicle is stopping.

In a further example, the staged external communication system may include a first step of modifying the behavior of the autonomous vehicle by applying a braking profile, such as multiple applications of the brakes in a pattern which generates higher levels of jerk of the vehicle to indicate that the autonomous vehicle is trying to stop in time, if the first step is ineffective, second step of flashing lights in a pattern which indicate a high rate of speed of the autonomous vehicle may be used, if the second step is ineffective, performing a third step of providing a notification to the road user on an eHMI notification display. The notification may be a message or a symbol which indicates that the autonomous vehicle is unable to stop in time.

In an aspect of the present disclosure, the autonomous vehicle may identify a road user by an image or series of images recorded by a plurality of vehicle sensors. The images may be timestamped by an image processor and analyzed for changes in motion, head pose, body posture, arm swing, stride length, mood state, direction of movement and gait.

The plurality of vehicle sensors may include a plurality of cameras located around the vehicle.

The plurality of vehicle sensors may include a plurality of LiDAR sensors. The autonomous vehicle may identify a road user by a series of images recorded by a LiDAR (light detection and ranging) rotating 360 degree scanner. LiDAR acts as an eye of an autonomous (self-driving) vehicle. It provides a 360-degree view of the surrounding area.

A continuously rotating LiDAR system sends thousands of laser pulses every second. These pulses collide with the surrounding objects and reflect back. The resulting light reflections are then used to create a 3D point cloud. The vehicle onboard computer records the reflection point of each laser and translates this rapidly updating point cloud into an animated 3D representation. The 3D representation is created by measuring the speed of light and the distance covered from the LiDAR device to an object and back to the LiDAR device (time of flight measurements) which helps to determine the position of the vehicle with respect to other surrounding objects.

The 3D representation may be used to monitor the distance between the autonomous vehicle and any other vehicles or pedestrians on the road passing by, in front, behind or in a common trajectory with the autonomous vehicle. Image processing of the LiDAR signals enables the vehicle to differentiate between a person on a bicycle or a person walking, and their speed and direction. The 3D representation may also be used to determine when to command the brakes to slow or stop the vehicle, or to speed up when the roadway is clear.

Additionally, the plurality of vehicle sensors may be radar sensors used to detect road users. The computer of the vehicle is configured to use data gathered by camera image analysis, LiDAR 3D point cloud analysis and radar to determine the gaze direction of the road user.

The autonomous vehicle may include a computer system having circuitry and stored program instructions that, when executed by one or more processor, determine the intent of the road user to enter a trajectory of the autonomous vehicle and whether the road user is able to see the behavioral changes. The autonomous vehicle may modify the deceleration profile or initiate additional lighting earlier if the road user is not able to see the behavioral changes, e.g., in a situation where the vehicle is partially blocked from the view of the road user by other vehicles. If the vehicle is completely blocked from view, the road user may not be able to determine changes in the vehicle trajectory, such as switching lanes, making turns or braking which may be signaled or otherwise communicated. In this situation, an audible signal, such as emitting “squealing” or “screeching” noises from a speaker may be more effective.

The additional lighting may be configured to display different colors, patterns, messages, or other visual data. The notification devices may also include a display device, such as an LCD or LED panel, a speaker configured to play audible messages, a windshield or window projector configured to cause visual data to be displayed on the windshield and/or windows of an autonomous vehicle, and/or a translucent display applied to, or replacing, one or more windows/windshields of the autonomous vehicle.

An autonomous vehicle may include a guidance system which makes use of the cameras, LiDAR scanners and radar images to determine images of the surrounding environment and moving objects. The autonomous vehicle may also connect in a mesh network with nearby autonomous vehicles to share their coordinates and trajectories, intention to change trajectory and road users sensed in their surroundings. The autonomous vehicle can determine whether the nearby autonomous vehicles are on a common or intersecting path and whether any of the road users are on the common or intersecting path. This shared information is provided to the environmental map for use in the staged communication system.

The processor may access image analysis circuitry which can use camera images, 3D point cloud and radar data to stitch together a representation of the surroundings of the autonomous vehicle and provide this representation to the autonomous guidance system. Movement within the surrounding environment can include current traffic and roadway conditions, nearby entities, autonomous vehicle status (e.g., speed, direction, etc.), and other data. Object recognition and computer vision techniques may be applied to the image data to identify road users, such as pedestrians, bicyclists and non-autonomous vehicles, as well as intersections and crosswalks.

In an aspect of the present disclosure, an autonomous vehicle uses sensing devices, such as LiDAR, cameras, and radar to monitor the external environment in which the autonomous vehicle is located. Monitoring the external environment can include generating image data which includes information regarding the external environment and including the image data on a map of the external environment. The map can include GPS data.

The plurality of sensing devices may include one or more cameras which generate images of one or more portions of the external environment, a light beam scanning device which generates one or more point clouds of one or more portions of the external environments and a radar device which generates radar data associated with one or more portions of the external environment.

The additional lighting may include a plurality of external lighting displays coupled to various portions of an exterior of the vehicle and which are configured to display one or more messages generated by the computing system of the vehicle. The displays may be liquid crystal display (LCD) screens, light-emitting diodes (LED) screens, a combination of a screen and a projector, or a roof top projector configured to project an image on the road surface. Headlights, brake lights, back-up lights and turn signals may also be used to display the intent of the autonomous vehicle. The displays may be bands of lights configured to flash in a pattern or sequence and according to a flashing profile which indicate the vehicle behavior to a road user. For example, a band of lights may flash all lights in the band on and off when at a first distance to a road user, and may flash fewer lights as the vehicle approaches a stop. The displays may be configured for adjustable positioning in order to display the message in the line of sight of the road user.

A computing system in the autonomous vehicle may include processing circuitry including an environment mapping module and a trajectory prediction module which are configured to predict a trajectory of a road user through the environment based on identifying various contextual cues associated with the road user. In an example, if the road user is a pedestrian, the environment mapping module may use the location, head pose, walking speed, body posture, and the like, to identify the gaze direction and perform a multi-gait analysis of the pedestrian's motion by detecting changes in motion, head pose, body posture, arm swing, stride length, mood state, direction of movement and gait. The environment mapping module may access a database of stored sets of images associated with poses, body posture, walking speeds, and the like, and may match each stitched image to a stored image to determine multi-gait analysis and the gaze direction. The trajectory prediction module may predict the trajectory of the road user from the gaze direction, location, speed and other body cues. For example, the age of the road user may be a factor in the determination of the gaze direction and the trajectory prediction. For example, a child may be smaller than an adult and may not be able to see the vehicle or recognize vehicle behavioral changes, therefore the most optimal communication may be a symbol or auditory warning. Seniors may have reduced neck motion, which may affect the determination of the gaze direction and/or the multi-gait analysis.

Similarly, if the road user is a bicyclist, the environment mapping module may use the location, head pose, speed, body posture changes (e.g., swinging motion, side to side motion, position of feet on the pedals, and the like) to identify the gaze direction and estimate the trajectory and speed of the bicyclist. The environment mapping module may access a database of stored sets of images associated with poses, body posture, speeds, and the like, and may match each stitched image to a stored image to determine a gaze direction, trajectory and intent of the bicyclist to depart from the trajectory. The trajectory prediction module may use the gaze direction to predict a trajectory of the bicyclist.

In a third example, if the road user is a non-autonomous vehicle, the environment mapping module may or may not be able to identify the intent of the driver. A computing system of the autonomous vehicle may use the windshield orientation to determine the direction Glare compensation of the images may be performed to identify at least some contextual cues, such as head pose, of the driver. If no contextual cues of the driver can be distinguished, the environment mapping module may use stitched images of the windshield orientation as the gaze direction.

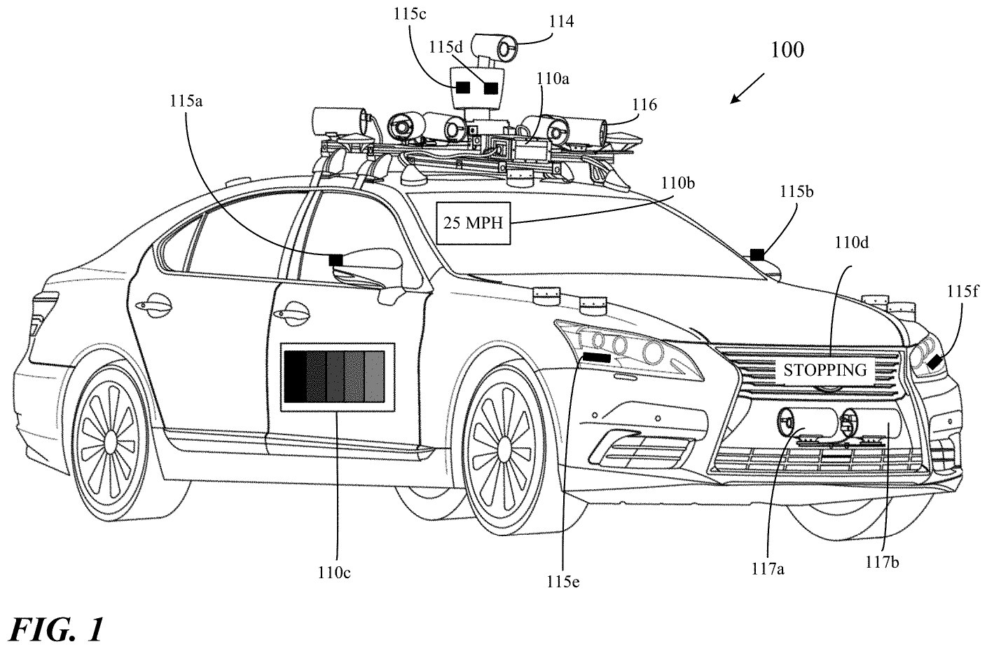

FIG. 1 illustrates an exemplary autonomous vehicle 100 having a turret (not shown) holding a plurality of LiDAR scanners (116) capturing a 360° view. The turret may hold radar sensors and cameras (115c, 115d), although the radar sensors and cameras may be placed on a plurality of locations on the vehicle. The autonomous vehicle further includes a plurality of cameras (115a-115f), a plurality of radar scanners (117a, 117b) on the front and rear of the vehicle (rear radar not shown). Further, the headlight housings (115e, 115f), side view mirrors (115a, 115b) or brake light housings may be configured with cameras. The autonomous vehicle may also have a plurality of cameras (not shown) and radar sensors (not shown) located around the body or on the roof of the vehicle.

The autonomous vehicle may include a plurality of additional lighting, including 360° projector 114, an eHMI display 110a on the roof, a front windshield display 110b, a door display 110c and a front grill display 110d. The autonomous vehicle is not limited to the number of additional lighting displays shown in FIG. 1, but may have a plurality of lighting displays as needed to alert of road user of the status of the autonomous vehicle. The additional lighting may also include any of an eHMI display 110b at the top of the windshield, on the side doors 110c, on the front grill 110d, on the rear bumper 110f and above or on the rear trunk lid or on the rear windshield 110g. The displays may be configured to display different symbols or messages. Additionally, the displays may show the same or different eHMI notifications directed towards the gaze directions of a plurality of road users. In the example of FIG. 1, display 110a may flash in a pattern, display 110b may show the current speed of the autonomous vehicle, display 110c may show light bars which light or change color in a pattern which indicates the speed of the vehicle, display 110d, mounted on the front grill, may provide an eHMI notification that the vehicle is stopping. The additional lighting of the present disclosure is not limited to the displays and lighting of FIG. 1, but may include a plurality of types of flashing light displays, eHMI displays, symbol displays, or the like, located around the vehicle.

Displays mounted on glass surfaces may be translucent or configured so that the eHMI can be displayed on the outside of the vehicle but appears clear to a passenger on the inside of the vehicle. The displays may be adjustable, rotatable or tiltable through actuation of motor(s) by a controller of a vehicle computing system in order to provide a road user the eHMI notification in the field of view indicated by his/her gaze direction.

The autonomous vehicle further includes active suspension components which can be actuated in real-time to lift the front, rear or either side of the vehicle to perform the brake dive or body roll. In general, an active suspension is a type of automotive suspension, such as a shock absorber or linear actuator, that controls the vertical movement of the wheels relative to the chassis or vehicle body, rather than in passive suspension where the movement is being determined entirely by the road surface. Active suspensions can use an actuator to raise and lower the chassis independently at each wheel. The onboard computer of the vehicle controls the action suspensions by either changing hydraulic pressure in shock absorbers or by motors which extend or collapse linear actuators. In a non-limiting example, the active suspension components may include long travel shock absorbers actuated by hydraulic pressure or by electric motors. In a further non-limiting example, the active suspension components can lift the front, rear, or either side of the autonomous vehicle by up to 39 inches from the vehicle frame.

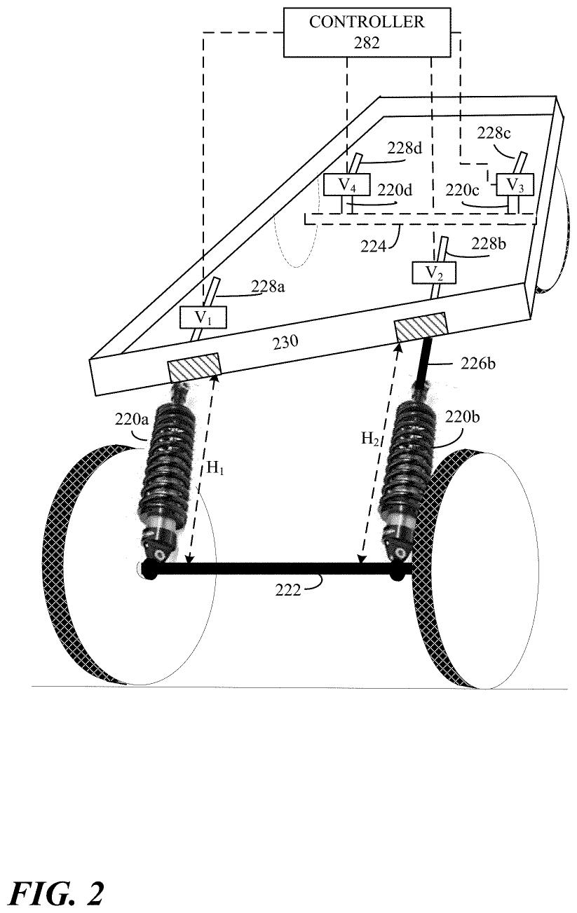

FIG. 2 illustrates a non-limiting example of raising a vehicle chassis on one side to perform a body roll maneuver. The vehicle has two long travel pneumatic shock absorbers (220a, 220b) located at a mount on the front axle 222, and two long travel pneumatic shock absorbers (220c, 220d) located on a mount on the rear axle 224. Each shock absorber is connected at its upper end to an extension arm (only 226b is shown). Each extension arm is connected to an air tank (228a, 228b, 228c, 228d). Each air tank is configured to release pressurized air into the shock absorber by a respective valve (V1, V2, V3, V4) connected to and electrically actuated by controller 282 (see dotted lines). In the example of FIG. 2, a left shock is 220a holds a vehicle chassis 230 at a height H₁ from axle 222. A right shock 220b is pneumatically extended to hold the vehicle chassis at a height H₂ from the axle 222. The lower end of each shock is mounted to a fitting which holds the axle, as is conventionally used and not explicitly shown here. The right rear shock absorber 220c is also raised to height H₂ to lift the right rear of the chassis above axle 224. Height H₂ in this example is greater than height H₁.

In a further non-limiting example of performing a body roll, shock absorbers 220a and 220d may lift the chassis 230 to a height H₂ and shock absorbers 220b and 220c may hold the chassis at height H₁, where H₁ is greater than H₂. Heights H₁ and H₂ may range from 0 to 39 inches, and are adjustable to any height within that range.

In another non-limiting example, the vehicle may perform a brake dive to mimic the action of the front end of a vehicle when abruptly stopping. In this example, both rear shock absorbers, 220c and 220d may be raised to a height H₂ and both front shock absorbers may be lowered to a height H₁, where H₂ is greater than H₁.

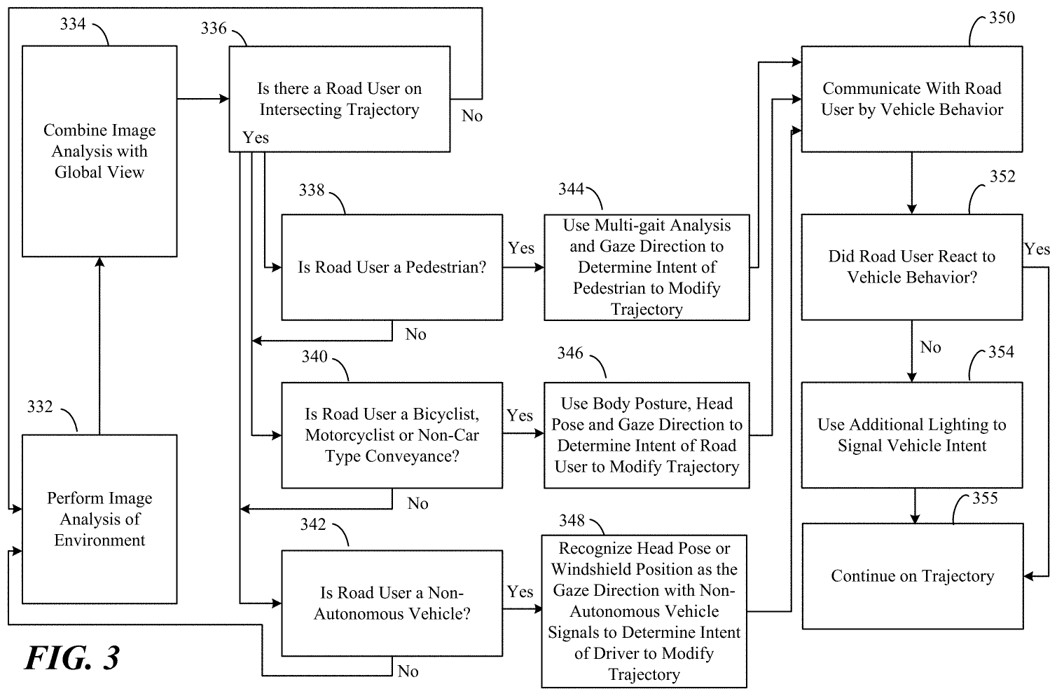

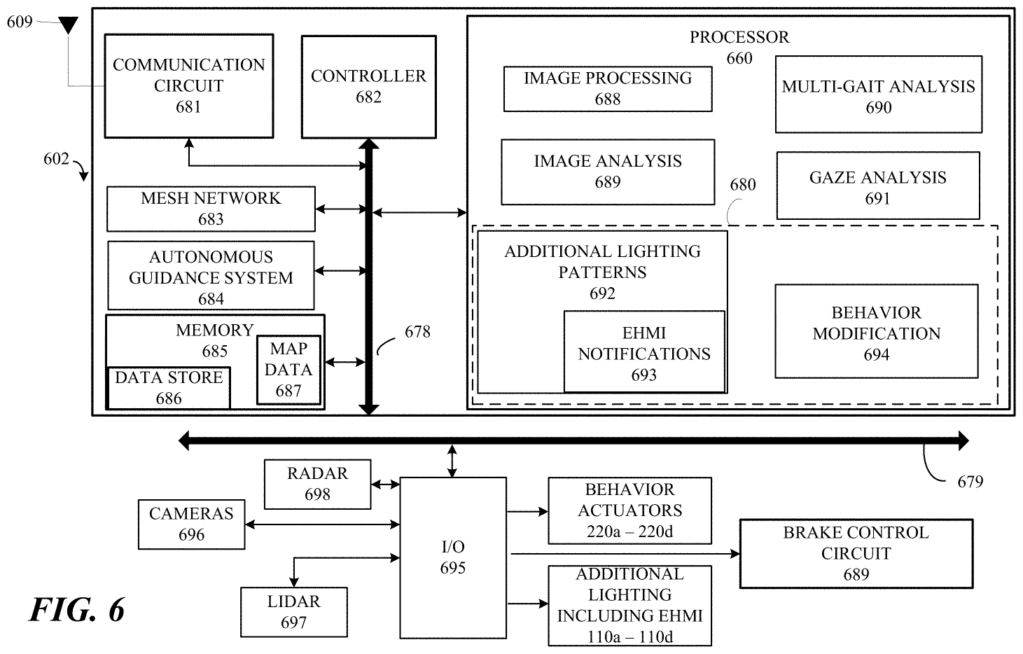

FIG. 3 is a flowchart of the staged external communication of the present disclosure. One or more sensors, e.g., cameras, LiDAR, radar, and the like, are utilized to provide images to an image analysis processor (see 684, FIG. 6). At step 332, an image analysis is performed and an environmental model is developed of the external surroundings of the autonomous vehicle. At step 334, the image analysis is combined with the global view. At step 336, it is determined whether a road user is on an intersecting trajectory with the autonomous vehicle. If no road user has been identified, the process returns to step 332. If a road user is identified, steps 338, 340 and 342 may be implemented in parallel or in series. At step 338, if the road user is a pedestrian, a multi-gait analysis at step 344 is performed and the gaze direction of the pedestrian is identified in order to determine whether the pedestrian sees the autonomous vehicle and predict whether the pedestrian intends to modify his/her trajectory. At step 340, the system determines whether the road user is a bicyclist, a motorcyclist or non-car conveyance, (such as a cart or buggy or the like). If the road user is a bicyclist, a motorcyclist or non-car conveyance, at step 346 the body posture, head pose and gaze direction of the bicyclist, a motorcyclist or driver of the non-car conveyance are used to determine whether the road user sees the autonomous vehicle and to predict whether the road user intends to modify his/her trajectory. At step 342, the system determines whether the road user is a non-autonomous vehicle. If the road user is a non-autonomous vehicle, the process moves to step 348, where the processor uses the images to recognize the head position and gaze direction (if available) of the driver. If the head position is not visible, the windshield orientation may be used to determine where the driver should be able to see. The processor may also recognize signals on the non-autonomous vehicle, such as headlights, turn signals, etc. Once the processor determines the intent of the road user (at 344, 346, and 348) the autonomous vehicle attempts to communicate with the road user by modifying vehicle behavior at step 350. The system then determines the reaction of the road user to the vehicle behavior at step 352. If the system recognizes the road user is not reacting to the vehicle behavior (by head pose, body posture, signaling, movement, etc.), the process moves to step 354, where additional external lighting is used to signal the intent of the autonomous vehicle.

In the first stage of the staged external communication, the autonomous vehicle may signal its intent with vehicle behavior which may include any of.

1. Lowering the front of the vehicle and raising the rear end in a brake dive to indicate that the vehicle intends to brake, slow down or come to a full stop.

2. Raising a side of the vehicle to give a body roll signal to indicate the autonomous vehicle intends to change lanes.

3. Stopping more abruptly or earlier on to indicate stopping to the road user.

4. Raising the vehicle (by extending shock absorbers, FIG. 2) to increase the perceived size of the vehicle.

5. Locking a wheel briefly and amplifying a sound to indicate the vehicle intends to come to an abrupt stop.

6. Decelerating more rapidly than normally to indicate the intent to stop.

7. A braking profile, such as multiple applications of the brakes in a pattern which generates a high level of jerk of the vehicle.

In the second stage of the staged external communication, the autonomous vehicle may signal its intent with additional external lighting which may include any of.

1. An eHMI display which indicates changes in speed of the autonomous vehicle.

2. An eHMI display which exhibits wording, such as “stopping”, “driving”, “left turn”, “right turn”, “changing lanes”, or the like.

3. An eHMI display which exhibits symbols or arrows.

4. A light bar which flashes lights in a pattern indicating the speed of the autonomous vehicle.

5. A lighting display which lights up in colors and/or includes sounds.

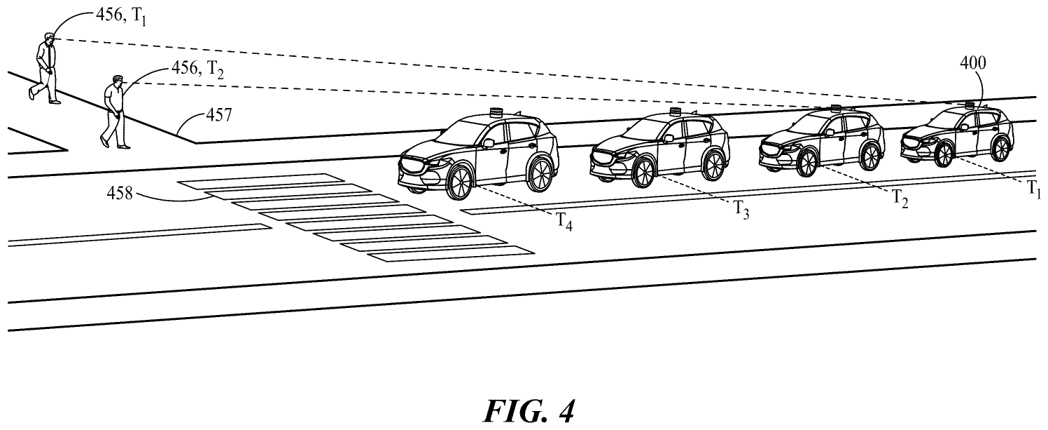

FIG. 4 illustrates an example of an autonomous vehicle 400 using the staged communication system to communicate with a pedestrian 456 who is travelling on a sidewalk 457 towards a crosswalk 458. At time T₁, the autonomous vehicle identifies the pedestrian and performs a multi-gait analysis between times T₁ and T₂. At time T₂, the gaze direction of the pedestrian is identified and the vehicle modifies its behavior between times T₂ and T₃ to indicate to the pedestrian that it intends to stop. The vehicle may use a braking profile, such as multiple application of the brakes in a pattern which generates higher levels of jerk for the vehicle. At time T3, the autonomous vehicle again observes the pedestrian to identify his/her reaction to the behavior modification. If the staged communication system determines the pedestrian has understood the behavior signal, by stopping or slowing down, for example, the autonomous vehicle may decelerate normally. However, if the pedestrian has not indicated recognition of the behavior signal, the staged communication will signal the vehicle's intent with the additional external lighting as described above.

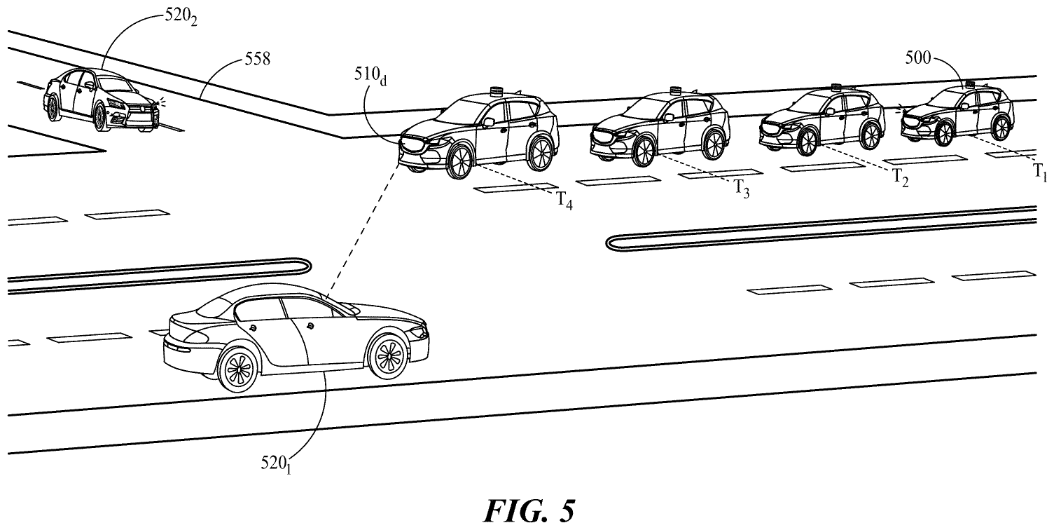

FIG. 5 illustrates an example of an autonomous vehicle 500 using the staged communication system to communicate with a non-autonomous vehicle 520₁ travelling in the opposite direction to autonomous vehicle 500 and perpendicularly to non-autonomous vehicle 520₂. The autonomous vehicle intends to make a right turn onto side road 558, and vehicle 520₁ is not able to see the right hand turn signal. At time T₁, the autonomous vehicle identifies the non-autonomous vehicles 520₁ and 520₂ and analyzes the head position and body posture of the driver each non-autonomous vehicle or windshield orientation between times T₁ and T₂. At time T₂, the gaze direction of the driver is identified and the autonomous vehicle modifies its behavior between times T₂ and T₃ to indicate to the drivers of that it intends to make a right turn. In a non-limiting example, the autonomous vehicle may use a body roll signal, in which the left side of the vehicle is raised with respect to the right side. At time T3, the autonomous vehicle again observes the drivers to identify their reaction to the behavior modification. If the staged communication system determines the drivers have understood the behavior signal, the autonomous vehicle may decelerate and turn right normally. However, if either driver of non-autonomous vehicle 520₁ or 520₂ has not indicated recognition of the behavior signal, the staged communication will signal the autonomous vehicle's intent with the additional external lighting (shown at 510d) as described above.

As shown in FIG. 6, the autonomous vehicle 100 includes a computing device 602 including a controller 682 and one or more processors 660. “Processor” means any component or group of components that are configured to execute any of the processes described herein or any form of instructions to carry out such processes or cause such processes to be performed. The processor 660 may be implemented with one or more general-purpose and/or one or more special-purpose processors. Examples of suitable processors include microprocessors, microcontrollers, DSP processors, and other circuitry that can execute software. Further examples of suitable processors include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, and a controller. The processor 660 can include at least one hardware circuit (e.g., an integrated circuit) configured to carry out instructions contained in program code. In arrangements in which there is a plurality of processors 660, such processors can work independently from each other or one or more processors can work in combination with each other. In one or more arrangements, the processor 660 can be a main processor of the vehicle 100. For instance, the processor 660 can be an engine control unit (ECU).

The vehicle 100 can include one or more data stores 686 for storing one or more types of data. The data store can include volatile and/or non-volatile memory (685). Examples of suitable data stores 686 include RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The data store 686 can be operatively connected to the processor 660 for use thereby. The term “operatively connected,” as used throughout this description, can include direct or indirect connections, including connections without direct physical contact.

In one or more arrangements, the one or more data stores 686 can include map data 687. The map data 687 can include maps of one or more geographic areas. The map data 687 can include information or data on roads, traffic control devices, road markings, structures, features, and/or landmarks in the one or more geographic areas. The map data 687 can be in any suitable form. In some instances, the map data 687 can include aerial views of an area. In some instances, the map data 687 can include ground views of an area, including 360 degree ground views. The map data 687 can be highly detailed. In some instances, the map data 687 can be located onboard the vehicle 100. Alternatively, at least a portion of the map data 687 can be located in a data store or source that is remote from the vehicle 100. The map data 687 can include terrain data. The terrain data can include information about the terrain of one or more geographic areas. The terrain data can include elevation data in the one or more geographic areas. In some instances, the terrain data can be located onboard the vehicle 100. The map data 687 can include a digital map with information about road geometry.

The computing device includes a first bus line 678 for connecting the internal components and a second bus line 679 for connecting the computing device with the vehicle sensors, lighting, brakes and behavior actuators.

The vehicle 100 can include an autonomous guidance system 684. The autonomous guidance system 684 can include instructions (e.g., program logic) executable by the processor 660. Such instructions can include instructions to execute various vehicle functions and/or to transmit data to, receive data from, interact with, and/or control the vehicle 100 or one or more systems thereof (e.g. one or more of vehicle systems). Alternatively or in addition, the data store 686 may contain such instructions. The autonomous guidance system 684 can be configured to determining path(s), current driving maneuvers for the vehicle 100, future driving maneuvers and/or modifications to current driving maneuvers. The autonomous guidance system 684 can also cause, directly or indirectly, such path(s), driving maneuvers, and/or modifications thereto to be implemented.

The computing system 602 may access one or more sensors configured to sense the external environment of the vehicle 100 or portions thereof. For instance, the sensors can be configured to acquire data of at least a portion of an external environment of the vehicle 100. For instance, the sensors can be configured to acquire data of at least a forward portion of an external environment of the vehicle 100. “Forward portion” means a portion of the external environment that is located in front of the vehicle in the travel direction of the vehicle. The forward portion can include portion of the external environment that are offset from the vehicle in the right and/or left lateral directions. Such environmental sensors can be configured to detect, determine, assess, monitor, measure, quantify and/or sense objects in at least a portion of the external environment of the vehicle 100 and/or information/data about such objects. Various examples of such sensors have been described herein. However, it will be understood that the embodiments are not limited to the particular sensors described.

When determining that the arrival time of the autonomous vehicle and the detected one or more other road users at the multi-stop intersection is substantially the same as based on predicted arrival times, a deceleration profile can include, in one example, stopping short of an originally intended stopping point in a current travel lane of the autonomous vehicle. The vehicle can be configured to stop a predetermined distance short of the originally intended stopping point. In one or more arrangements, the driving maneuver can include decelerating so that the arrival time of the autonomous vehicle is not substantially the same as the predicted arrival time of the detected one or more other objects at the multi-stop intersection. For example, the driving maneuver includes decelerating so that the arrival time of the autonomous vehicle is later than the predicted arrival time of the detected one or more other objects at the multi-stop intersection.

The autonomous vehicle can be caused to implement the determined vehicle behavior. For instance, the staged external communication module 680, the autonomous guidance system 684, and/or the processor 660 can control the navigation and/or maneuvering of the vehicle 100 by controlling one or more of vehicle systems and/or components thereof. Such controlling can be performed directly or indirectly (e.g., by controlling one or more actuators). In one or more arrangements, causing the autonomous vehicle to implement the determined driving maneuver can be performed responsive to receiving permission to implement the determined driving maneuver. In such case, a vehicle occupant can be prompted to provide permission to implement the determined driving maneuver. In one or more arrangements, causing the autonomous vehicle to implement the determined driving maneuver can be performed automatically.

In response to determining that the trajectories of the autonomous vehicle and a road user will intersect, a driving maneuver for the vehicle 100 can be determined. The driving maneuver may be communicated by vehicle signals, and by a staged external communication system 680 using behavior modification (694) and additional external lighting (692).

The vehicle 100 can be caused (e.g. by the processor 660, the autonomous guidance system 684) to implement the determined behavior modification. For purposes of this example, the behavior modification can include stopping short of an intended stopping point in the current travel lane. For instance, the behavior modification can include stopping short of a stop line by a predetermined distance. An example of the vehicle 100 implementing such a driving maneuver is shown in FIG. 5. The predetermined distance can have any suitable value (e.g., about 5 meters or less, about 4 meters or less, about 3 meters or less, about 2 meters or less, about 1 meter or less). In this way, the vehicle 100 can signal to the non-autonomous vehicles 520₁ and 520₂ that it intends to allow them to proceed through the intersection first. Once the non-autonomous vehicles 520₁ and 520₂ pass through the intersection, the vehicle 100 can proceed through the intersection.

Although the autonomous communication device is shown in a single system, the autonomous communication device may be distributed across multiple systems and/or integrated into an autonomous vehicle controller. Additionally, processor modules may be performed by any number of different computers and/or systems. Thus, the modules may be separated into multiple services and/or over multiple different systems within the vehicle to perform the functionality described herein.

The first embodiment is illustrated with respect to FIG. 1-FIG. 6. The first embodiment describes a method for multi-stage communication between an autonomous vehicle 100 and a road user (456, FIG. 4, non-autonomous vehicles 520₁, 520₂, FIG. 5, or a bicyclist (not shown), or a motorcyclist (not shown)), comprising identifying a future interaction between the autonomous vehicle and a road user by one or more sensors (steps 332, 334 and 336, FIG. 3), performing a vehicle behavior modification as a first stage communication (step 350), recognizing whether the road user is reacting to the vehicle behavior modification (step 352), and activating additional external lighting as a second stage communication (step 354) when the road user is not reacting to the vehicle behavior modification.

The method further includes receiving image data from any one of a plurality of vehicle external cameras (115a-115f), a plurality of LiDAR sensors (116) and a plurality of radar sensors, (117a, 117b), processing the images to form a view of the environment surrounding the autonomous vehicle, identifying a first trajectory of the autonomous vehicle, and identifying a road user moving on a second trajectory which intersects the first trajectory (image processing 688 and image analysis 689, FIG. 6).

As shown in FIG. 3 and FIG. 4, the method further includes identifying the road user as a pedestrian 456 moving towards the first trajectory the direction of autonomous vehicle 400 at step 338, performing a multi-gait analysis of the pedestrian and determining a gaze direction of the pedestrian (step 344), and identifying the future interaction based on the multi-gait analysis and the gaze direction. Performing the multi-gait analysis includes determining the age, environment, arm swing, stride length, mood state and direction of movement of the pedestrian. Determining the gaze direction of the pedestrian includes detecting a head pose of the pedestrian which indicates that the pedestrian sees the autonomous vehicle.

As shown in FIG. 3 and FIG. 4, the method further includes identifying the road user as a bicyclist moving towards the first trajectory (step 340), determining a body posture and head pose of the bicyclist, determining a gaze direction of the bicyclist and identifying the future interaction based on the body posture, the head pose and the gaze direction (step 346).

The method further includes identifying the road user as a motorcyclist moving towards the first trajectory (step 340), determining a body posture and head pose of the motorcyclist, determining a gaze direction of the motorcyclist, and identifying the future interaction based on the body posture, the head pose and the gaze direction (step 346).

The method further includes performing the vehicle behavior modification by increasing the height of at least one suspension member (220a, 220b, 220c, 220d, FIG. 2). wherein increasing the height of at least one suspension member includes electrically actuating (by controller 282) a valve (V₁, V₂, V₃ or V₄) which controls a pneumatic pressure in the suspension member.

The method further includes at least one of performing the vehicle behavior modification by locking one wheel at one second intervals, performing the vehicle behavior modification by performing a deceleration profile which includes rapid deceleration, performing the vehicle behavior modification by performing a deceleration profile which includes braking abruptly at one second intervals and performing the vehicle behavior modification by performing a deceleration profile which includes stopping at a greater distance from the road user than the distance necessary to stop.

The method further includes activating additional external lighting by providing an electronic vehicle intent (eHMI) notification to a display (110a-110d and others not shown in FIG. 1) on the autonomous vehicle which is within the gaze direction of the road user.

The second stage includes activating additional lighting by at least one of flashing lights on a light bar, flashing a plurality of lights in a pattern, flashing a plurality of lights in color patterns, flashing a plurality of lights in sequence (e.g., as shown by display 110c, FIG. 1).

The second stage further includes displaying an electronic vehicle intent notification (eHMI) including at least one of a symbol, text and a symbol and text.

The second stage further includes at least one of displaying an eHMI notification on a plurality of display locations on the autonomous vehicle, displaying a plurality of eHMI notifications, each at a different location on the autonomous vehicle, and actuating a rotating lamp on a roof of the autonomous vehicle.

The second embodiment is illustrated with respect to FIG. 1-FIG. 6. The second embodiment describes a system for multi-stage communication between an autonomous vehicle 100 and a road user (456, FIG. 4, non-autonomous vehicles 520₁, 520₂, FIG. 5, or a bicyclist (not shown), or a motorcyclist (not shown)), comprising the autonomous vehicle 100 including a first plurality of sensors (vehicle external cameras (115a-115f), LiDAR sensors (116) and radar sensors, (117a, 117b)) configured to generate images of the surrounding environment, a second plurality of suspension actuators (220a, 220b, 220c, 220d with valves V₁-V₄ and air tanks 228a-228d)) for raising and lowering the vehicle chassis 230, wherein the second plurality are configured for independent actuation, a third plurality of eHMI notification displays (110a-110d, and others not shown in FIG. 1) located at different external positions on the autonomous vehicle, wherein the third plurality are configured for independent activation, a fourth plurality of additional external lighting displays (a light bar, such as 110c, or a rotating light on the roof of the autonomous vehicle (not shown)), wherein the fourth plurality are configured for independent activation, a computing device 602 (FIG. 6) operatively connected to the first, second, third and fourth pluralities, the computing device including a computer-readable medium comprising program instructions (memory 685), executable by processing circuitry (processor 660), to cause the processing circuitry to receive image data from any one of the first plurality of sensors, the sensors including vehicle external cameras (115a-115f), LiDAR sensors (116) and radar sensors (117a, 117b), process the images to form a view of the environment surrounding the autonomous vehicle (steps 332, 334, FIG. 3), combine the view of the environment with map data identifying a first trajectory of the autonomous vehicle (step 336), identify a road user moving on a second trajectory which intersects the first trajectory, determine a gaze direction of the road user, estimate the intent of the road user to intersect a trajectory of the autonomous vehicle (steps 344, 346, or 348), perform a vehicle behavior modification as a first stage communication (step 350), recognize whether the road user is reacting to the vehicle behavior modification (step 352), and activate one or more of the third plurality of eHMI notification displays and the fourth plurality of additional external lighting as a second stage communication (step 354) when the road user is not reacting to the vehicle behavior modification.

As shown in FIG. 6, the computing device wherein the processing circuitry is further configured to timestamp the images from the first plurality of sensors (see image processing 688), execute the program instructions to combine the map data with the timestamped images to form the global view of the environment surrounding the autonomous vehicle, identify the road user in the global view, estimate the intent of the road user to move on the second trajectory by analyzing a plurality of successive images of the road user and identifying changes between the successive images to determine the motion of the road user towards the first trajectory of the autonomous vehicle, and determine the gaze direction of the road user by analyzing the head pose and body posture of the road user.

The computing device further comprises a controller 682, a brake control circuit 689 operatively connected to the controller, wherein the controller (282, FIG. 2, 682, FIG. 6) is configured to actuate each of the second plurality of suspension actuators to raise and lower the vehicle chassis (see controller 282, FIG. 2 connected to valves V₁-V₄), wherein the processing circuitry is configured to provide a braking profile (behavior modification patterns, 689) to the controller to operate the brake control circuit to perform the behavior modification, and wherein the processing circuitry is further configured to provide an actuation pattern to the controller to actuate the second plurality of suspension actuators to perform a behavior modification selected from one of a brake dive signal and a body roll signal.

The computing device is operatively connected to a brake (not shown) of the autonomous vehicle, and the processing circuitry is further configured to provide the second stage communication to the controller to perform at least one of activating additional lighting by at least one of flashing lights on a light bar, flashing a plurality of lights in a pattern, flashing a plurality of lights in color patterns, flashing a plurality of lights in sequence, displaying an electronic vehicle intent notification (eHMI) including at least one of a symbol, text, a symbol and text, displaying an eHMI notification on a plurality of display locations on the autonomous vehicle, displaying a plurality of eHMI notifications, each at a different location on the autonomous vehicle, and activating a rotating lamp on a roof of the autonomous vehicle.

The third embodiment is illustrated with respect to FIG. 1-FIG. 10. The third embodiment describes a non-transitory computer readable medium having instructions stored therein that, when executed by one or more processors, cause the one or more processors to perform a method for multi-stage communication between an autonomous vehicle 100 and a road user (456, FIG. 4, non-autonomous vehicles 520₁, 520₂, FIG. 5, or a bicyclist (not shown), or a motorcyclist (not shown)), comprising identifying a future interaction between the autonomous vehicle and a road user by one or more sensors (steps 332, 334 and 336, FIG. 3), performing a vehicle behavior modification as a first stage communication (step 350), recognizing whether the road user is reacting to the vehicle behavior modification (step 352), and activating additional external lighting as a second stage communication (step 354) when the road user is not reacting to the vehicle behavior modification.

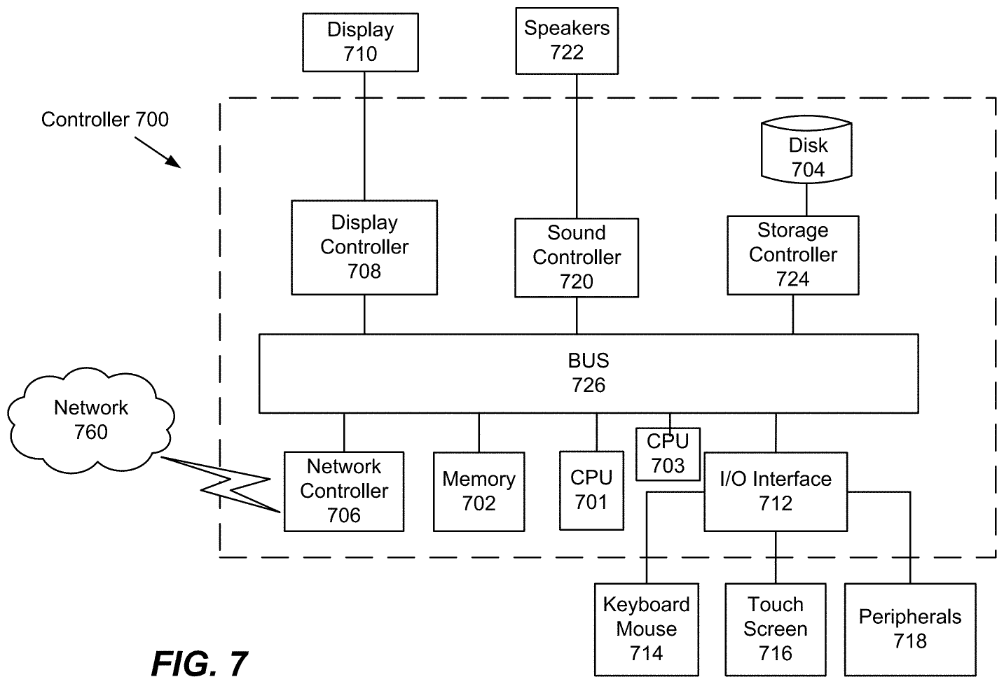

Next, further details of the hardware description of the computing environment of FIG. 6 according to exemplary embodiments is described with reference to FIG. 7. In FIG. 7, a controller 700 is described is representative of the controller 682 of the system 600 of FIG. 6 in which the controller is a computing device which includes a CPU 701 which performs the processes described above/below. The process data and instructions may be stored in memory 702. These processes and instructions may also be stored on a storage medium disk 704 such as a hard drive (HDD) or portable storage medium or may be stored remotely.

Further, the claims are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the computing device communicates, such as a server or computer.

Further, the claims may be provided as a utility application, background daemon, or component of an operating system, or combination thereof, executing in conjunction with CPU 701, 703 and an operating system such as Microsoft Windows 7, UNIX, Solaris, LINUX, Apple MAC-OS and other systems known to those skilled in the art.

The hardware elements in order to achieve the computing device may be realized by various circuitry elements, known to those skilled in the art. For example, CPU 701 or CPU 703 may be a Xenon or Core processor from Intel of America or an Opteron processor from AMD of America, or may be other processor types that would be recognized by one of ordinary skill in the art. Alternatively, the CPU 701, 703 may be implemented on an FPGA, ASIC, PLD or using discrete logic circuits, as one of ordinary skill in the art would recognize. Further, CPU 701, 703 may be implemented as multiple processors cooperatively working in parallel to perform the instructions of the inventive processes described above.

The computing device in FIG. 7 also includes a network controller 706, such as an Intel Ethernet PRO network interface card from Intel Corporation of America, for interfacing with network 760. As can be appreciated, the network 760 can be a public network, such as the Internet, or a private network such as an LAN or WAN network, or any combination thereof and can also include PSTN or ISDN sub-networks. The network 760 can also be wired, such as an Ethernet network, or can be wireless such as a cellular network including EDGE, 3G and 4G wireless cellular systems. The wireless network can also be WiFi, Bluetooth, or any other wireless form of communication that is known.

The computing device further includes a display controller 708, such as a NVIDIA GeForce GTX or Quadro graphics adaptor from NVIDIA Corporation of America for interfacing with display 710, such as a Hewlett Packard HPL2445w LCD monitor. A general purpose I/O interface 712 interfaces with a keyboard and/or mouse 714 as well as a touch screen panel 716 on or separate from display 710. General purpose I/O interface also connects to a variety of peripherals 718 including printers and scanners, such as an OfficeJet or DeskJet from Hewlett Packard.

A sound controller 720 is also provided in the computing device such as Sound Blaster X-Fi Titanium from Creative, to interface with speakers/microphone 722 thereby providing sounds and/or music.

The general purpose storage controller 724 connects the storage medium disk 704 with communication bus 726, which may be an ISA, EISA, VESA, PCI, or similar, for interconnecting all of the components of the computing device. A description of the general features and functionality of the display 710, keyboard and/or mouse 714, as well as the display controller 708, storage controller 724, network controller 706, sound controller 720, and general purpose I/O interface 712 is omitted herein for brevity as these features are known.

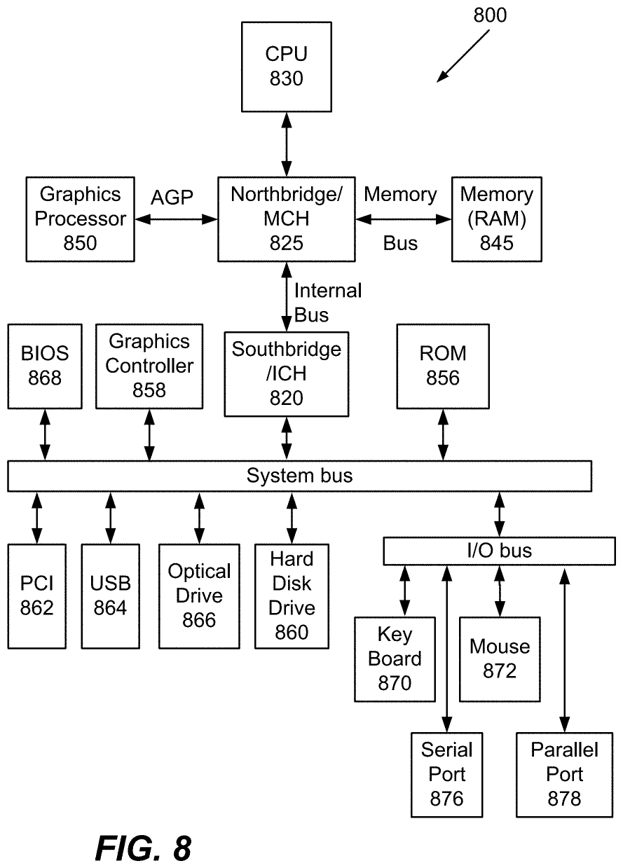

The exemplary circuit elements described in the context of the present disclosure may be replaced with other elements and structured differently than the examples provided herein. Moreover, circuitry configured to perform features described herein may be implemented in multiple circuit units (e.g., chips), or the features may be combined in circuitry on a single chipset, as shown on FIG. 8.

FIG. 8 shows a schematic diagram of a data processing system, according to certain embodiments, for performing the functions of the exemplary embodiments. The data processing system is an example of a computer in which code or instructions implementing the processes of the illustrative embodiments may be located.

In FIG. 8, data processing system 800 employs a hub architecture including a north bridge and memory controller hub (NB/MCH) 825 and a south bridge and input/output (I/O) controller hub (SB/ICH) 820. The central processing unit (CPU) 830 is connected to NB/MCH 825. The NB/MCH 825 also connects to the memory 845 via a memory bus, and connects to the graphics processor 850 via an accelerated graphics port (AGP). The NB/MCH 825 also connects to the SB/ICH 820 via an internal bus (e.g., a unified media interface or a direct media interface). The CPU Processing unit 830 may contain one or more processors and even may be implemented using one or more heterogeneous processor systems.

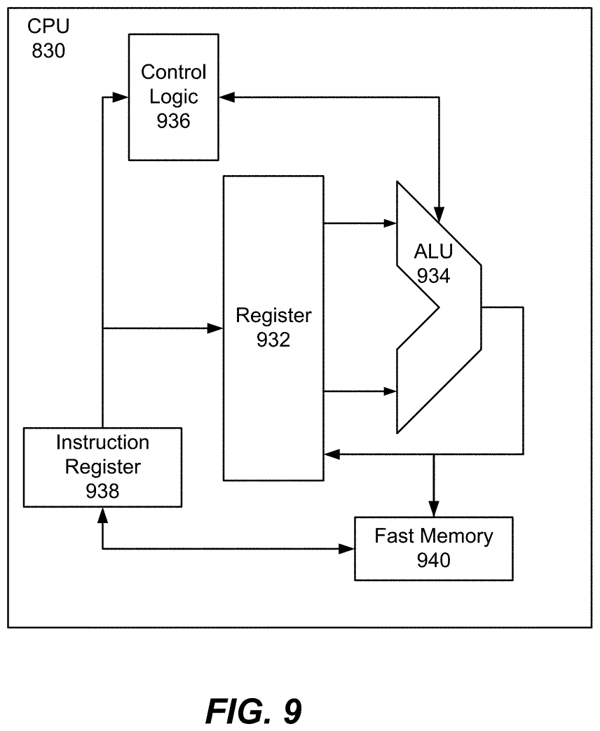

For example, FIG. 9 shows one implementation of CPU 830. In one implementation, the instruction register 938 retrieves instructions from the fast memory 940. At least part of these instructions are fetched from the instruction register 938 by the control logic 936 and interpreted according to the instruction set architecture of the CPU 830. Part of the instructions can also be directed to the register 932. In one implementation the instructions are decoded according to a hardwired method, and in another implementation the instructions are decoded according a microprogram that translates instructions into sets of CPU configuration signals that are applied sequentially over multiple clock pulses. After fetching and decoding the instructions, the instructions are executed using the arithmetic logic unit (ALU) 934 that loads values from the register 932 and performs logical and mathematical operations on the loaded values according to the instructions. The results from these operations can be feedback into the register and/or stored in the fast memory 940. According to certain implementations, the instruction set architecture of the CPU 830 can use a reduced instruction set architecture, a complex instruction set architecture, a vector processor architecture, a very large instruction word architecture. Furthermore, the CPU 830 can be based on the Von Neuman model or the Harvard model. The CPU 830 can be a digital signal processor, an FPGA, an ASIC, a PLA, a PLD, or a CPLD. Further, the CPU 830 can be an x86 processor by Intel or by AMD; an ARM processor, a Power architecture processor by, e.g., IBM; a SPARC architecture processor by Sun Microsystems or by Oracle; or other known CPU architecture.

Referring again to FIG. 8, the data processing system 800 can include that the SB/ICH 820 is coupled through a system bus to an I/O Bus, a read only memory (ROM) 856, universal serial bus (USB) port 864, a flash binary input/output system (BIOS) 868, and a graphics controller 858. PCI/PCIe devices can also be coupled to SB/ICH 888 through a PCI bus 862.

The PCI devices may include, for example, Ethernet adapters, add-in cards, and PC cards for notebook computers. The Hard disk drive 860 and CD-ROM 866 can use, for example, an integrated drive electronics (IDE) or serial advanced technology attachment (SATA) interface. In one implementation the I/O bus can include a super I/O (SIO) device.

Further, the hard disk drive (HDD) 860 and optical drive 866 can also be coupled to the SB/ICH 820 through a system bus. In one implementation, a keyboard 870, a mouse 872, a parallel port 878, and a serial port 876 can be connected to the system bus through the I/O bus. Other peripherals and devices that can be connected to the SB/ICH 820 using a mass storage controller such as SATA or PATA, an Ethernet port, an ISA bus, a LPC bridge, SMBus, a DMA controller, and an Audio Codec.

Moreover, the present disclosure is not limited to the specific circuit elements described herein, nor is the present disclosure limited to the specific sizing and classification of these elements. For example, the skilled artisan will appreciate that the circuitry described herein may be adapted based on changes on battery sizing and chemistry, or based on the requirements of the intended back-up load to be powered.

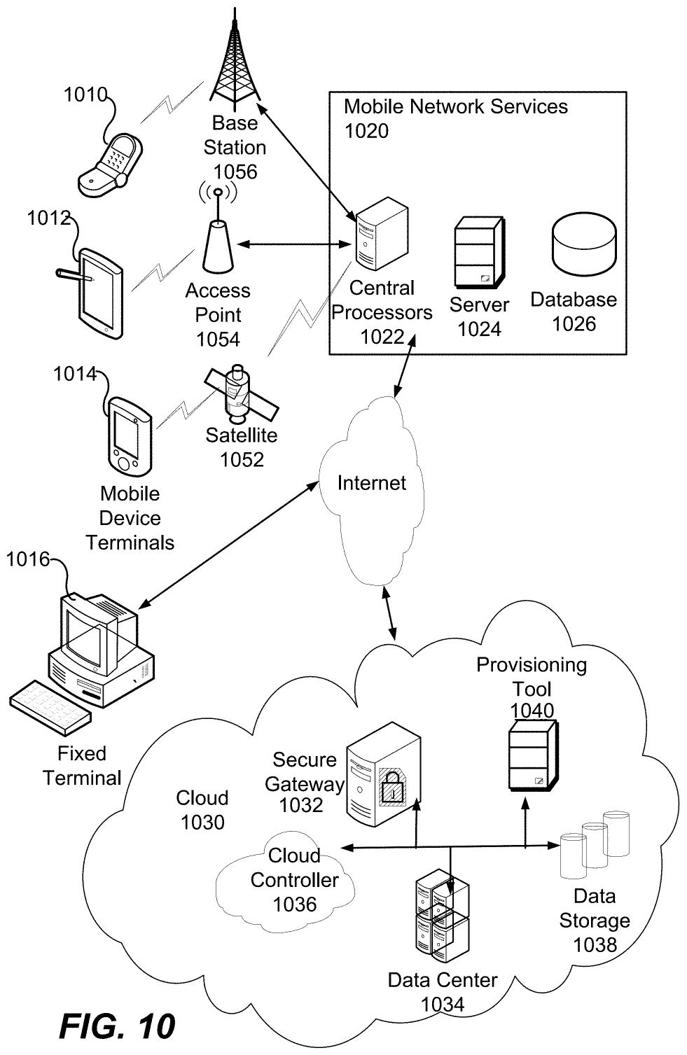

The functions and features described herein may also be executed by various distributed components of a system. For example, one or more processors may execute these system functions, wherein the processors are distributed across multiple components communicating in a network. The distributed components may include one or more client and server machines, which may share processing, as shown by FIG. 10, in addition to various human interface and communication devices (e.g., display monitors, smart phones, tablets, personal digital assistants (PDAs)). The network may be a private network, such as a LAN or WAN, or may be a public network, such as the Internet. Input to the system may be received via direct user input and received remotely either in real-time or as a batch process. Additionally, some implementations may be performed on modules or hardware not identical to those described. Accordingly, other implementations are within the scope that may be claimed.

The above-described hardware description is a non-limiting example of corresponding structure for performing the functionality described herein.

Obviously, numerous modifications and variations of the present disclosure are possible in light of the above teachings. It is therefore to be understood that within the scope of the appended claims, the invention may be practiced otherwise than as specifically described herein.

1. A method for multi-stage communication between an autonomous vehicle and a road user, comprising:
identifying a future interaction between the autonomous vehicle and a road user by one or more sensors;
performing a vehicle behavior modification as a first stage communication;
recognizing whether the road user is reacting to the vehicle behavior modification; and
activating additional external lighting as a second stage communication when the road user is not reacting to the vehicle behavior modification.

2. The method of claim 1, further comprising:
receiving image data from any one of a plurality of vehicle external cameras, a plurality of LiDAR sensors and a plurality of radar sensors;
processing the images to form a view of the environment surrounding the autonomous vehicle;
identifying a first trajectory of the autonomous vehicle; and
identifying a road user moving on a second trajectory which intersects the first trajectory.

3. The method of claim 2, further comprising:
identifying the road user as a pedestrian moving towards the first trajectory;
performing a multi-gait analysis of the pedestrian;
determining a gaze direction of the pedestrian; and
identifying the future interaction based on the multi-gait analysis and the gaze direction.

4. The method of claim 3, wherein performing the multi-gait analysis includes determining at least one of the age, environment, arm swing, stride length, mood state and direction of movement of the pedestrian.

5. The method of claim 3, wherein determining the gaze direction of the pedestrian includes detecting a head pose of the pedestrian which indicates that the pedestrian sees the autonomous vehicle.

6. The method of claim 2, further comprising:
identifying the road user as a bicyclist moving towards the first trajectory;
determining a body posture and head pose of the bicyclist;
determining a gaze direction of the bicyclist; and
identifying the future interaction based on the body posture, the head pose and the gaze direction.

7. The method of claim 2, further comprising:
identifying the road user as a motorcyclist moving towards the trajectory;
determining a body posture and head pose of the motorcyclist;
determining a gaze direction of the motorcyclist; and
identifying the future interaction based on the body posture, the head pose and the gaze direction.

8. The method of claim 2, further comprising:
performing the vehicle behavior modification by increasing the height of at least one suspension member.

9. The method of claim 8, further comprising:
increasing the height of at least one suspension member by electrically actuating a valve which controls a pneumatic pressure in the suspension member.

10. The method of claim 2, further comprising:
performing the vehicle behavior modification by locking one wheel at one second intervals; and optionally
emitting a high pitched noise from a speaker of the autonomous vehicle.

11. The method of claim 2, further comprising:
performing the vehicle behavior modification by performing a deceleration profile which includes rapid deceleration.

12. The method of claim 2, further comprising:
performing the vehicle behavior modification by performing a deceleration profile which includes braking abruptly at one second intervals.

13. The method of claim 2, further comprising:
performing the vehicle behavior modification by performing a deceleration profile which includes stopping at a greater distance from the road user than the distance necessary to stop.

14. The method of claim 1, further comprising:
activating additional external lighting by providing an electronic vehicle intent (eHMI) notification to a display on the autonomous vehicle which is within the gaze direction of the road user.

15. The method of claim 1, further comprising at least one of:
activating additional lighting by at least one of:
flashing lights on a light bar;
flashing a plurality of lights in a pattern;
flashing a plurality of lights in color patterns;
flashing a plurality of lights in sequence;
displaying an electronic vehicle intent notification (eHMI) including at least one of:
a symbol;
text;
a symbol and text;
displaying an eHMI notification on a plurality of display locations on the autonomous vehicle;
displaying a plurality of eHMI notifications, each at a different location on the autonomous vehicle; and
actuating a rotating lamp on a roof of the autonomous vehicle.

16. A system for multi-stage communication between an autonomous vehicle and a road user, comprising:
the autonomous vehicle including:
a plurality of sensors configured to generate images of the surrounding environment, the plurality of sensors including vehicle external cameras, LiDAR sensors and radar sensors;
a plurality of suspension actuators for raising and lowering the vehicle chassis, wherein the plurality of suspension actuators are configured for independent actuation;
a plurality of eHMI notification displays located at different external positions on the autonomous vehicle, wherein the plurality of eHMI notification displays are configured for independent activation;
a plurality of additional external lighting displays, wherein the fourth plurality are configured for independent activation;
a computing device including a computer-readable medium comprising program instructions, executable by processing circuitry, to cause the processing circuitry to:
receive image data from any one of the plurality of sensors;
process the images to form a global view of the environment surrounding the autonomous vehicle;
identify a first trajectory of the autonomous vehicle from the global view;
identify a road user moving on a second trajectory which intersects the first trajectory;
determine a gaze direction of the road user;
estimate the intent of the road user to intersect a trajectory of the autonomous vehicle;
perform a vehicle behavior modification as a first stage communication;
recognize whether the road user is reacting to the vehicle behavior modification; and
activate one or more of the plurality of eHMI notification displays and the plurality of additional external lighting as a second stage communication when the road user is not reacting to the vehicle behavior modification.

17. The system of claim 16, wherein the processing circuitry is further configured to:
timestamp the images from the first plurality of sensors;
execute the program instructions to form the global view of the environment surrounding the autonomous vehicle;
identify the road user in the global view;
estimate the intent of the road user to move on the second trajectory by analyzing a plurality of successive images of the road user and identifying changes between the successive images to determine the motion of the road user towards the first trajectory of the autonomous vehicle; and
determine the gaze direction of the road user by analyzing the head pose and body posture of the road user.

18. The system of claim 17, wherein the computing device further comprises:
a controller;
a brake control circuit operatively connected to the controller;
wherein the controller is configured to actuate each of the plurality of suspension actuators to raise and lower the vehicle chassis;
wherein the processing circuitry is configured to provide a braking profile to the controller to operate the brake control circuit to perform the behavior modification; and
wherein the processing circuitry is further configured to provide an actuation pattern to the controller to actuate the plurality of suspension actuators to perform a behavior modification selected from one of a brake dive signal and a body roll signal.

19. The system of claim 18, wherein the computing device is operatively connected to a brake of the autonomous vehicle; and
the processing circuitry is further configured to provide the second stage communication to the controller to perform at least one of:
activating additional lighting by at least one of:
flashing lights on a light bar;
flashing a plurality of lights in a pattern;
flashing a plurality of lights in color patterns;
flashing a plurality of lights in sequence;
displaying an electronic vehicle intent notification (eHMI) including at least one of:
a symbol;
text;
a symbol and text;
displaying an eHMI notification on a plurality of display locations on the autonomous vehicle;
displaying a plurality of eHMI notifications, each at a different location on the autonomous vehicle; and
activating a rotating lamp on a roof of the autonomous vehicle.

20. A non-transitory computer readable medium having instructions stored therein that, when executed by one or more processors, cause the one or more processors to perform a method for multi-stage communication between an autonomous vehicle and a road user, comprising:
identifying a future interaction between the autonomous vehicle and a road user by one or more sensors;
performing a vehicle behavior modification as a first stage communication;
recognizing whether the road user is reacting to the vehicle behavior modification; and
activating additional external lighting as a second stage communication when the road user is not reacting to the vehicle behavior modification.
